(19) United States
(12) Patent Application Publication
(10) Pub. No.: US 2004/0003172 A1
(43) Pub. Date: Jan. 1, 2004

(54) Fast disc write mechanism in hard disc drives

(76) Inventors: Hui Su, Longmont, CO (US); Steven S. Williams, Longmont, CO (US)

Correspondence Address: David K. Lucente, Seagate Technology LLC, Intellectual Property - COL2LGL, 389 Disc Drive, Longmont, CO, 80503-0001, US

(21) Appl. No.: 10/447,516

(22) Filed: May 29, 2003

Related U.S. Application Data
(60) Provisional application No. 60/392,959, filed on Jul. 1, 2002.

(51) Int. Cl. G06F 12/00

(52) U.S. Cl. 711/112; 711/173; 711/113

(57) ABSTRACT

A scheme by which a data storage device may present a rapid write ability. Upon receiving a write command, the data storage device enters the data into a cache. Thereafter, the storage device determines whether the write command meets criteria for execution of the fast disc write method. If so, the storage device waits until a trigger event, whereupon the storage device moves the data from the cache to a first area on the recording medium. The first area is chosen so as to be an area that is susceptible of relatively higher recording rates than a second area of the recording medium. After having moved the data from the cache to the first area, the storage device waits for the occurrence of a second trigger event. Upon occurrence of the second trigger event, the data is moved from the first area to its ultimate destination on the second area.

### RELATED APPLICATIONS

This application claims priority of U.S. provisional application Ser. No. 60/392,959, filed Jul. 1, 2002 and entitled “FAST DISC WRITE MECHANISM IN HARD DISC DRIVES.”

### FIELD OF THE INVENTION

This application relates generally to disc drives and more particularly to a fast disc writing scheme utilizing a buffer area on a disc.

### BACKGROUND OF THE INVENTION

Disc drives are commonly used as the main devices by which large quantities of data are stored and retrieved in computing systems. For example, it is common for a host system to transfer as much as 100 MB/s for storage to a disc drive. In the near future, the serial ATA standard will support data rates much higher. For example, in 2006, the ATA serial standard is expected to support 1280 MB/s.

Disc drives are unable to read or write data to the storage medium at rates equal to that at which the host transfers data to or from the disc drive. This speed differential between the interface and the ability of the disc drive to read and write data to and from the disc causes the system to pause while the disc drive “catches up.” To counter this problem, several approaches have been pursued. For example, with respect to enhancing the ability of the disc drive to transfer data to the host, disc drives often read ahead. By reading ahead, the disc drive literally anticipates future read commands before they are transferred to the disc drive, so that much of the data is already read and stored in a buffer by the time the read command is received. Thus, the disc drive is able to quickly respond to the read command, so that it appears to the host that the disc drive is actually capable of reading data at a rate equal to the interface speed.

Heretofore, it has proven to be more difficult to develop schemes to enhance the perceived performance of the disc drive to write to the disc. For example, it is plain to see that it is impossible to write ahead to a disc drive, because it is not possible to anticipate the data to be written to the disc. Further complicating the ability of a disc drive to quickly record data to a disc is that data recording speeds vary based upon where the data is to be recorded. For example, a peripheral track of a disc contains more sectors per track than does a centrally located track. As a consequence, when writing data to a central region of the disc, the disc drive must change tracks more often. This results in data recording rates dropping by approximately one-half. As a worst-case scenario, the disc drive may receive small write commands randomly dispersed across the disc, meaning that the disc drive must change tracks and wait for the disc to spin to the appropriate orientation between execution of each write command. This can cause the data recordation rate to drop by more than an order of magnitude. As mentioned previously, when a disc drive is unable to record data at the rate at which data is transferred to the drive, the host is forced to stop supplying data until the disc drive catches up. This effect is undesirable, as it results in noticeable pauses to the user of the host computing system.

As is evident from the foregoing, there is a need for a scheme by which write commands may be made to appear to have been quickly executed. A successful scheme will present little jeopardy with respect to data loss, and will be relatively inexpensive to implement.

### SUMMARY OF THE INVENTION

Against this backdrop the present invention was developed. According to one embodiment of the invention, a method of rapidly storing data to a data-retaining surface having a first data storage area and a second data storage area, wherein the second data storage area is susceptible of storing less data per unit of time than the first data storage area may include the following acts. A unit of data and a command to write the unit of data to a specified location in the second data storage area of the data-retaining surface is received from a host. The unit of data is written to the first data storage area of the data-retaining surface. A first event, the occurrence of which indicates that the unit of data is to be moved to the second data storage area of the data retaining surface, is awaited. The unit of data is written to the specified location in the second data storage area, after occurrence of the first event.

According to another embodiment of the invention, a disc drive may include a microprocessor that receives commands from a host, and a cache memory accessible by the microprocessor. The disc drive may also include a transducer that writes to a disc. The transducer may be disposed at the distal end of an actuator arm, which may be propelled by a servo system under control of the microprocessor. The disc has a first data storage area and a second data storage area, wherein the second data storage area is susceptible of storing less data per unit of time than the first data storage area. The microprocessor is programmed to undertake the acts as described above.

According to yet another embodiment of the invention, a disc drive may include a magnetically encodable disc. Further the disc drive may include a means for receiving from a host a command to write a unit of data to the disc, and initially writing the unit of data to a peripheral region of the disc. Upon the occurrence of an event, the unit of data may be written to a region of the disc that is more centrally located than the peripheral region.

### BRIEF DESCRIPTION OF THE DRAWINGS

FIG. 1 is a schematic representation of a disc drive in accordance with a preferred embodiment of the invention.

FIG. 2 illustrates a disc drive system connected to a host for the disc drive of FIG. 1.

FIG. 3 depicts a recording medium having a first and second data recording region, in accordance with one embodiment of the present invention.

FIG. 4 depicts a flow of operation for a fast disc write mechanism, according to one embodiment of the present invention.

FIG. 5 depicts a scheme for a fast disc write mechanism, according to one embodiment of the present invention.

FIG. 6 depicts a portion of a signal flow diagram for a fast disc write mechanism, according to one embodiment of the present invention.

FIG. 7 depicts a method for writing to a disc according to a fast disc write mechanism, according to one embodiment of the present invention.

FIG. 8 depicts another method for writing to a disc according to a fast disc write mechanism, according to one embodiment of the present invention.

FIG. 9 depicts yet another method for writing to a disc according to a fast disc write mechanism, according to one embodiment of the present invention.

FIG. 10A depicts yet another method for writing to a disc according to a fast disc write mechanism, according to one embodiment of the present invention.

FIG. 10B depicts yet another method for writing to a disc according to a fast disc write mechanism, according to one embodiment of the present invention.

FIG. 11 depicts a portion of a signal flow diagram for a read operation in a device having a cache and a scratch pad, according to one embodiment of the present invention.

FIG. 12 depicts a method of performing a read operation, according to one embodiment of the present invention.

FIG. 13 depicts another method of performing a read operation, according to one embodiment of the present invention.

FIG. 14 depicts tactics for updating and invalidating entries in the scratch pad table, according to one embodiment of the present invention.

### DETAILED DECRYPTION OF THE INVENTION

A scheme by which a data storage device may operate so as to present a perceived rapid write ability to a host may be accomplished as follows. Upon receiving a write command, the data storage device enters the data to be stored into a cache memory. Thereafter, the storage device determines whether the write command meets certain criteria for execution of the fast disc write method. If so, the storage device awaits a trigger event, whereupon the storage device moves the data from the cache to a first area on the recording medium. The first area is chosen so as to be an area that is susceptible of relatively higher recording rates than a second area of the recording medium. For example, the first area may be a set of peripherally located tracks on the recording medium, while the second area is a set of centrally located tracks. The trigger event may be defined by the quantity of data stored in the cache, or by failing to receive a command from the host for a given period, for example. After having moved the data from the cache to the first area on the recording medium, the storage device waits for the occurrence of a second trigger event. Upon occurrence of the second trigger event, the data is moved from the first area on the surface of the recording medium to its ultimate destination on the second area. Thus, the storage device enhances its perceived ability to record data by making use of multiple levels of buffering prior to recording the data to its ultimate destination.

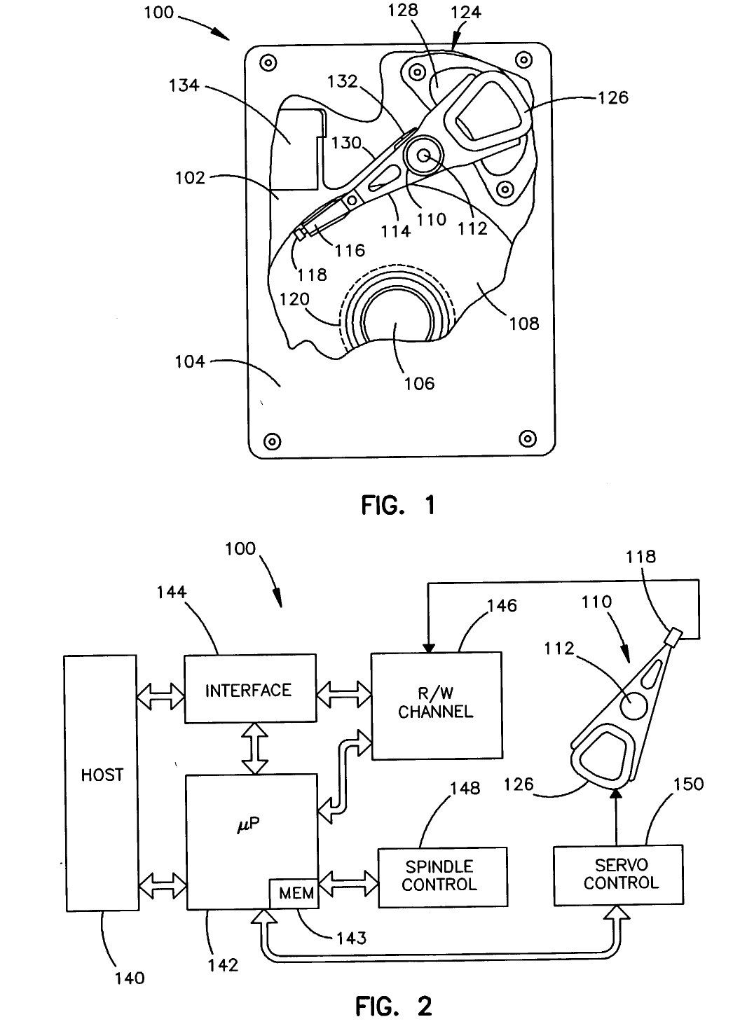

In the disclosure that follows, the discussion related to FIGS. 1 and 2 is intended to generally present disc technology—one example of a suitable setting for the present invention. (One skilled in the art understands that the invention is susceptible of deployment in other environments, such as a readable/writeable CD ROM). The discussion relating to the remaining figures focuses more particularly on the invention, itself.

A disc drive 100 constructed in accordance with a preferred embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106 which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118 which includes an air bearing slider enabling the head 118 to fly in close proximity above the corresponding surface of the associated disc 108.

During a seek operation, the track position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well known Lorentz relationship. As the coil 126 moves, the actuator assembly 110 pivots about the bearing shaft assembly 112, and the heads 118 are caused to move across the surfaces of the discs 108.

The spindle motor 116 is typically de-energized when the disc drive 100 is not in use for extended periods of time. The heads 118 are moved over park zones 120 near the inner diameter of the discs 108 when the drive motor is de-energized. The heads 118 are secured over the park zones 120 through the use of an actuator latch arrangement, which prevents inadvertent rotation of the actuator assembly 110 when the heads are parked.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and for amplifying read signals generated by the heads 118 during a read operation. The flex assembly terminates at a flex bracket 134 for communication through the base deck 102 to a disc drive printed circuit board (not shown) mounted to the bottom side of the disc drive 100.

Referring now to FIG. 2, shown therein is a functional block diagram of the disc drive 100 of FIG. 1, generally showing the main functional circuits which are resident on the disc drive printed circuit board and used to control the operation of the disc drive 100. The disc drive 100 is shown in FIG. 2 to be operably connected to a host computer 140 in which the disc drive 100 is mounted in a conventional manner. Control communication paths are provided between the host computer 140 and a disc drive microprocessor 142, the microprocessor 142 generally providing top level communication and control for the disc drive 100 in conjunction with programming for the microprocessor 142 stored in microprocessor memory (MEM) 143. The MEM 143 can include random access memory (RAM), read only memory (ROM) and other sources of resident memory for the microprocessor 142.

The discs 108 are rotated at a constant high speed by a spindle control circuit 148, which typically electrically commutates the spindle motor 106 (FIG. 1) through the use of back electromotive force (BEMF) sensing. During a seek operation, the track position of the heads 118 is controlled through the application of current to the coil 126 of the actuator assembly 110. A servo control circuit 150 provides such control. During a seek operation the microprocessor 142 receives information regarding the velocity and acceleration of the head 118, and uses that information in conjunction with a model, stored in memory 143, of the plant to generate the response of the servomechanism to a feed-forward control signal.

Data is transferred between the host computer 140 and the disc drive 100 by way of a disc drive interface 144, which typically includes a buffer to facilitate high speed data transfer between the host computer 140 and the disc drive 100. Data to be written to the disc drive 100 are thus passed from the host computer to the interface 144 and then to a read/write channel 146, which encodes and serializes the data and provides the requisite write current signals to the heads 118. To retrieve data that has been previously stored by the disc drive 100, read signals are generated by the heads 118 and provided to the read/write channel 146, which performs decoding and error detection and correction operations and outputs the retrieved data to the interface 144 for subsequent transfer to the host computer 140.

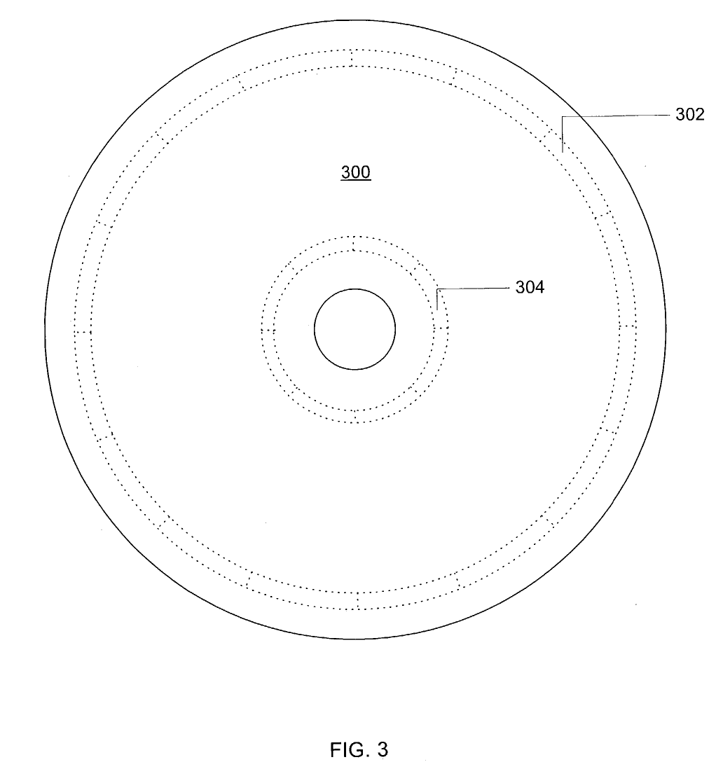

FIG. 3 depicts a recording medium 300. The recording medium 300 may be a flat, annular magnetically encodable disc, as generally found in disc drives. Alternatively, the recording medium 300 may be a readable/writeable optical disc. For the purpose of illustration, the recording medium 300 will be described herein as a magnetically encodable disc, and the storage device in which it is found will be described as a disc drive. Neither condition is essential for deployment of the invention. As can be seen from FIG. 3, the disc 300 has a peripheral track 302 and a centrally located track 304. The peripheral track 302 is depicted as containing sixteen sectors, while the centrally located track 304 is depicted as containing only eight sectors. Consequently, twice as much data may be written to the peripheral track 302 before a track change is necessitated, as compared to the central track 304. Accordingly, a disc drive may write data to peripheral tracks (such as 302) at a higher rate than is possible for centrally located tracks (such as 304). Thus, broadly speaking, a disc (such as 300) may be described as having two regions, a first region (generally peripheral) in which data recording may be accomplished relatively quickly, and a second region (generally more central as compared to the peripheral region) in which data recording may be accomplished at a rate slower than in the first region.

From the foregoing, it follows that write operations that are directed toward centrally-located tracks are more time consuming than write operations directed toward peripherally located tracks. In addition, randomly dispersed write operations in which small units of data are written generally consume the most amount of time, because the disc drive must perform seek operations to change tracks, and must wait for the disc to spin to the proper orientation before writing each small unit of data.

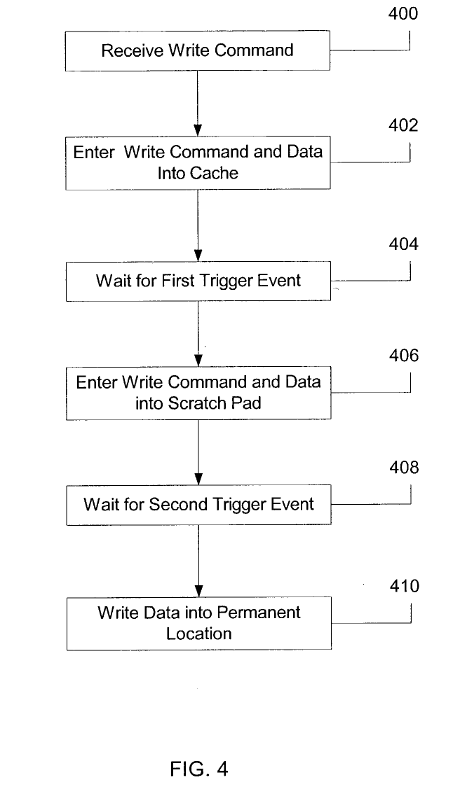

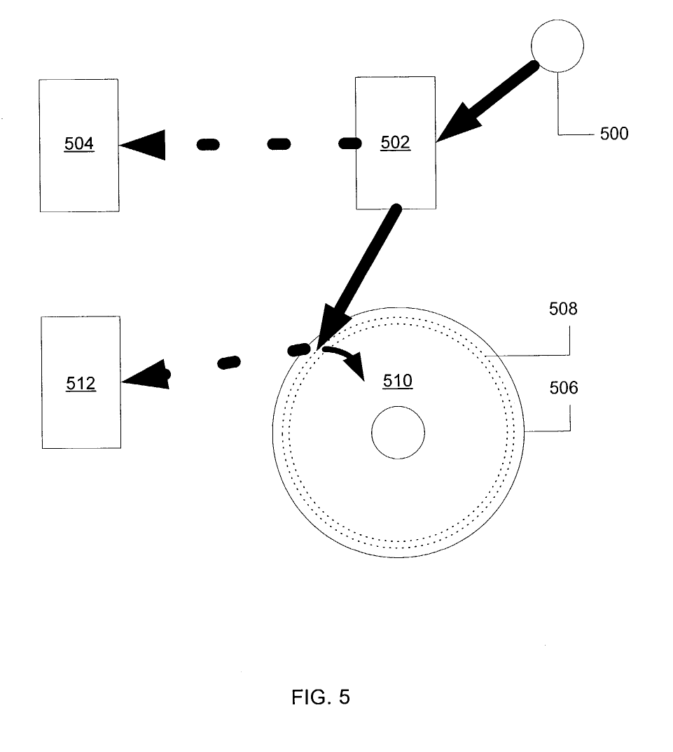

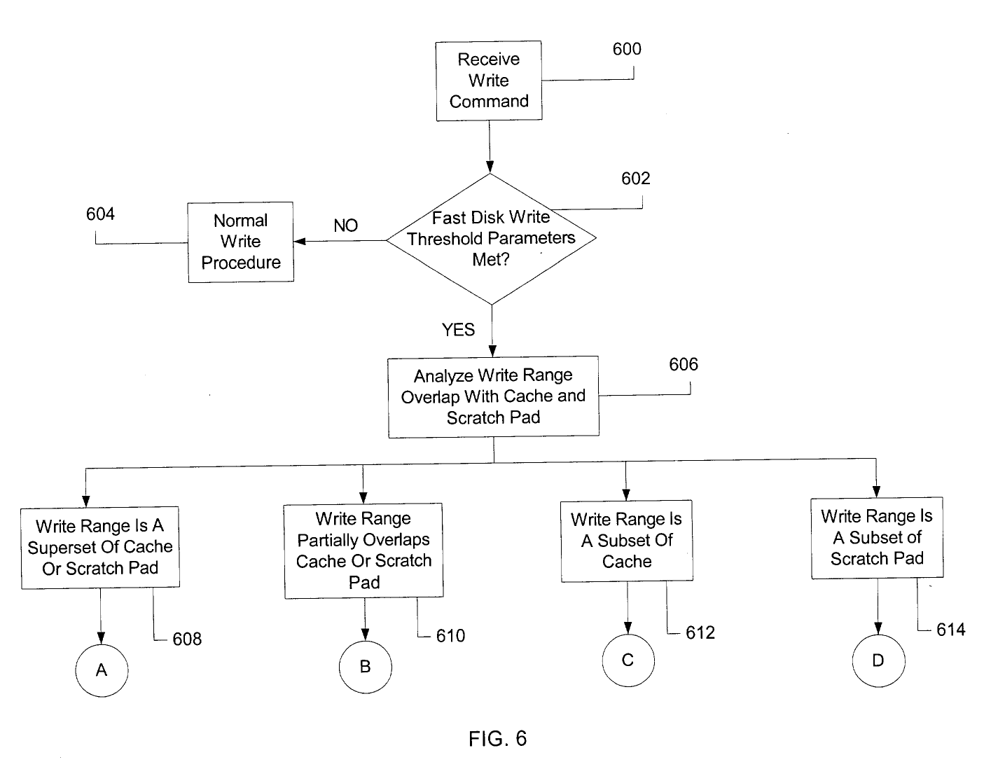

FIGS. 4 and 5 jointly depict a general scheme by which the peripheral tracks of a disc may be used as a buffer. The scheme is initiated, as shown in operation 400 of FIG. 4, by the reception of a write command. The write command typically includes a set of data to be written to the disc and a description of the location on the disc to which the set of data should be written. The write command is depicted graphically in FIG. 5 by reference numeral 500.

Initially, after receiving the write command, the write data and the location description are entered into a cache memory 502 (FIG. 5), as depicted in operation 402 of FIG. 4. The cache memory 502 may be accessed by the interface circuitry 144 (FIG. 2), the microprocessor 142 (FIG. 2), or the read/write channel 146 (FIG. 2). The cache memory 502 has a data-recording rate that is faster than the data-recording rate of the peripheral regions of the disc (such as 302). When the write command 500 is entered into the cache 502, a table 504 is also updated. The table 504 keeps track of the identity of data in the cache 502 and where the data is to be located upon the disc 300. The table may be stored in the same cache device 502, or may be stored in another memory unit, such as memory device 143 (FIG. 2). The process of caching write data, and the techniques used for updating the table 504 are known in the art and are therefore not discussed in detail herein.

After entering the write command 500 into the cache 502, a first trigger event is awaited, as depicted by operation 404 (FIG. 4). The first trigger event may be defined by more than a certain amount of data being held in the cache 502 (e.g., a first trigger event is declared when more than N bytes of data are held in the cache 502). Alternatively, the first trigger event may be defined by failure to receive a command from the host 140 (FIG. 2) for more than a given amount of time. Upon occurrence of the first trigger event, the write command is moved from the cache 502 to one or more of a set of peripheral tracks 508 of the disc 506, as depicted in operation 406 (FIG. 4). As mentioned previously, peripheral tracks 508 are susceptible of relatively fast recording rates, because of their capacity to contain more data. Thus, a set of generally peripheral tracks (such as 508) are set aside and reserved as a buffer area, referred to herein as a “scratch pad” 508 (although FIG. 5 depicts the scratch pad as including only a single track, a scratch pad may include many tracks, which may be either contiguous or not). Write commands (such as 500), therefore, require that the write data be ultimately recorded in a region of the disc other than the scratch pad 508. However, write data is first recorded in the scratch pad 508 before being committed its ultimate destination toward the interior 510 of the disc 506. As was the case with entry of data into the cache 502, entry of write data into the scratch pad 508 requires update of a table 512. The table 512 may be stored in a writeable non-volatile memory device, including a flash memory device, an MRAM device, an FRAM device, or upon an area of the disc 506, itself. The table 512 is responsible for keeping track of the identity of the data entered in the scratch pad 508, including where the data is to be ultimately recorded. Details regarding one embodiment of such a table 512 are discussed below. For present purposes, it is sufficient to state the following about the table 512. The table contains an entry for each unit of data entered into the scratch pad 508. When the table 512 is said to be updated, it is meant that the table is manipulated in some fashion (e.g., a new entry is added to the table) so as to reflect the identity of a new entry of data into the cache. When one or more units of data in the scratch pad 508 are said to be invalidated, it is meant that the table 512 is manipulated in some fashion so as to render the invalidated data effectively not present in the scratch pad (i.e., invalidated data is “skipped over”).

After entering the write data 500 into the scratch pad 508, a second trigger event is awaited, as depicted by operation 408 (FIG. 4). The second trigger event may be defined by more than a certain amount of data being held in the scratch pad 508 (e.g., a second trigger event is declared when more than M bytes of data are held in the scratch pad 508). Alternatively, the second trigger event may be defined by a failure to receive a command from the host 140 (FIG. 2) for more than a given period of time. Upon occurrence of the second trigger event, the write data is written to its ultimate destination in the interior 510 of the disc 506.

Implementation of the above-described scheme has the general effect of causing the disc drive to undertake more time-consuming methods of data recording when the disc drive would otherwise be idle, or when there is simply no other alternative (the cache 502 and/or scratch pad 508 is full). For example, assume the scenario in which the disc drive receives a long string of essentially randomly dispersed short write commands. Initially, the disc drive responds by entering each of the commands into the cache 502. When the cache 502 becomes full, the data is entered into the scratch pad 508. Notably, by entering the data into the scratch pad 508, the disc drive obviates the need for performing a seek operation for each small unit of data. Instead, all of the data is written, as an agglomerated unit, into the scratch pad 508—a portion of the disc that is, itself, susceptible of the fastest rates of recordation. If the string of short write commands ends prior to the scratch pad 508 becoming full, then the data held in the scratch pad 508 is moved to its ultimate destination in the interior 510 of the disc during the ensuing period of idleness. Accordingly, the host 140 (FIG. 2) is not faced with waiting to transfer data to the disc drive while the disc drive performs individual seek and write operations in the wake of the cache 502 becoming full.

FIG. 6 depicts a more detailed flow of operation of the scheme for implementation of rapid writing to the disc. As can be seen from FIG. 6, the method is commenced by reception of a write command, as shown in operation 600. Thereafter, as shown in operation 602, the disc drive may determine whether or not the fast disc write mechanism should be employed at all. The determination made in operation 602 may be made, in whole or in part, based upon the following factors: (1) the length of the data set to be written to the disc (e.g., the fast disc write mechanism is employed if the write data is less than a certain number of bytes in length); (2) the specified location of the write command (e.g., if the write command specifies a location sufficiently near the periphery of the disc, the fast disc write mechanism is not employed); and (3) whether or not the present write command specifies a location that is consecutive with the previous write command (e.g., if the presently specified location is consecutive with the last specified location, the fast disc write mechanism is not employed). If the fast disc write mechanism is not to be employed, then the normal write procedure is invoked, as shown in operation 604. If, on the other hand, the fast disc write mechanism is to be invoked, then the flow of operation proceeds to operation 606, in which overlap conditions with the cache 502 and/or scratch pad 508 are identified.

Prior to entry of the newly received write command into either the cache 502 or the scratch pad 508, it is useful to determine whether the write location overlaps data locations already held in either the cache 502 or the scratch pad 508. As shown in FIG. 6, there are four possible outcomes of the overlap analysis of operation 606: (1) the write range is a superset of an entry in either the cache 502 or the scratch pad 508, as shown in outcome 608; (2) the write range partially overlaps an entry in the cache 502 or scratch pad 508, as shown in outcome 610; (3) the write range is a subset of an entry in the cache 502, as shown in outcome 612; and (4) the write range is a subset of an entry in the scratch pad 508, as shown in outcome 614. The overlap identification step depicted in step 606 may be conducted either via firmware or by an application-specific integrated circuit designed to quickly yield such results.

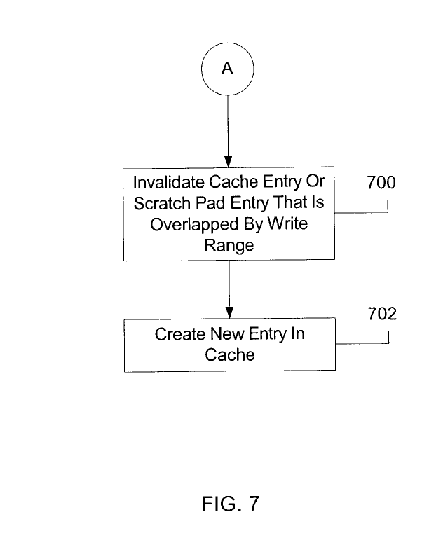

FIG. 7 depicts the steps taken in response to a write command when it is determined that the write range is a superset of an entry in either the cache 502 or scratch pad 508. An example of a scenario in which the write range is a superset of data held in the cache 502 or scratch pad 508 is as follows. The cache 502 holds logical blocks 1 through 50, and the range of the newly received write command is logical blocks 1 through 75. In this instance, the disc drive responds by invalidating the overlapping blocks in cache 502 (if the overlapping blocks were in the scratch pad 508, the overlapping blocks therein are invalidated), as shown in operation 700. The purpose of invalidating these logical blocks (logical blocks 1 through 50 in this example) is to ensure that “old” data is not committed to the disc at a later point in time. Examples of how to invalidate overlapping sectors in the scratch pad 508 are discussed below. Next, as shown in operation 702, the newly-received write data is entered into the cache 502, and a new cache entry is created in the cache table 504 (cache table is updated to reflect newly added data).

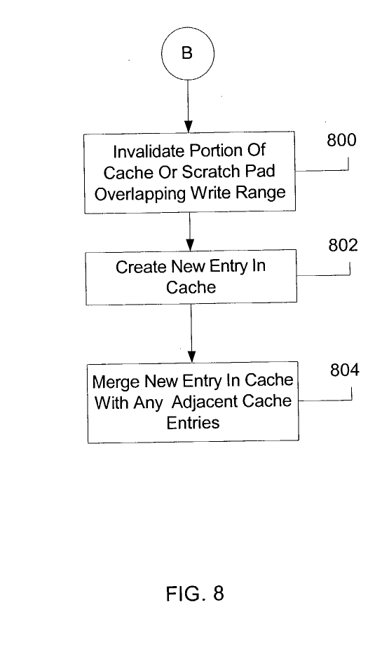

FIG. 8 depicts the steps taken in response to a write command when it is determined that the write range partially overlaps an entry in the cache 502 or scratch pad 508. An example of a scenario in which the write range partially overlaps data held in the cache 502 or scratch pad 508 is as follows. The cache 502 holds logical blocks 1 through 50, and the range of the newly received write command is logical blocks 25 through 100. In this instance, the disc drive responds by invalidating the overlapping blocks in cache 502 (logical blocks 25 through 50, in this example) (again, if the overlapping blocks were in the scratch pad 508, the overlapping blocks therein are invalidated), as shown in operation 800. Next, the newly-received write data is entered into the cache 502, and a new cache entry is created in the cache table 504 (the cache table 504 is updated to reflect newly added data), as shown in operation 802. Finally, as shown in operation 804, the cache table 504 is examined for the purpose of identifying cache table entries that are adjacent to the newly-created entry. In this case, one such adjacent entry must exist. In the wake of operation 800 (in which logical blocks 25-50 were invalidated), the cache table 504 would have an entry indicating that the cache 502 holds data to be stored on the disc beginning at logical block 1 and ending at logical block 24. The newly-created cache table 504 entry indicates that the cache 502 also holds data to be stored on the disc beginning at logical block 25 and ending at logical block 100—adjacent to the aforementioned entry. Thus, the two cache table entries are consolidated to a single entry indicating that the cache 502 holds data to be stored beginning at logical block 1 and ending at logical block 100. Further, the data associated with each of the aforementioned cache table 504 entries are “linked” into a single unit. For example, the cache 502 may be organized such that a single unit of data is comprised of a plurality of smaller quanta of data. Each quantum of data may contain a pointer linking the quantum to another quantum in the same data unit. Per such a scheme, two separate units of data may be agglomerated by assigning the last pointer in one of the two link lists to point at the beginning of the other unit of data.

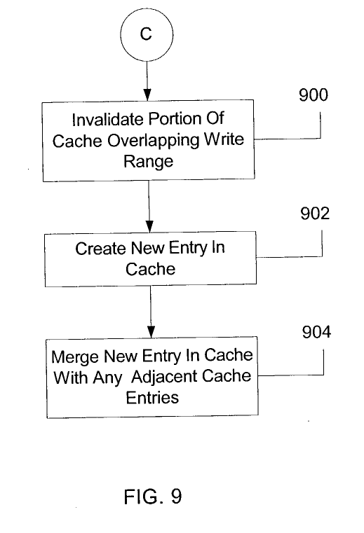

FIG. 9 depicts the steps taken in response to a write command when it is determined that the write range is a subset of an entry in the cache 502. An example of a scenario in which the write range is a subset of an entry in the cache 502 is as follows. The cache 502 holds logical blocks 1 through 50, while the range of the newly received write command is logical blocks 20 through 30. In this instance, the disc drive responds by invalidating the overlapping blocks in cache 502 (logical blocks 20 through 30, in this example), as shown in operation 900. Next, the newly-received write data is entered into the cache 502, and a new cache entry is created in the cache table 504 (the cache table 504 is updated to reflect newly added data), as shown in operation 902. Finally, as shown in operation 904, the cache table 504 is examined for the purpose of identifying cache table 504 entries that are adjacent to the newly-created entry. In this example, the cache table contains three entries in the wake of operation 902: (1) a first entry indicates that the cache 502 also holds data to be stored on the disc beginning at logical block 1 and ending at logical block 19; (2) a second entry indicates that the cache 502 holds data to be stored on the disc beginning at logical block 31 and ending at logical block 50; and (3) the newly created entry indicates that the cache 502 holds newly entered data to be stored on the disc beginning at logical block 20 and ending at logical block 30. Because the first and second cache table 504 entries are adjacent to the newly created entry, they are merged into a single entry indicating that the cache 502 holds data to be stored on the disc beginning at logical block 1 and ending at logical block 50 (the data in the cache 502 is also agglomerated into a single unit, as described above with reference to FIG. 8).

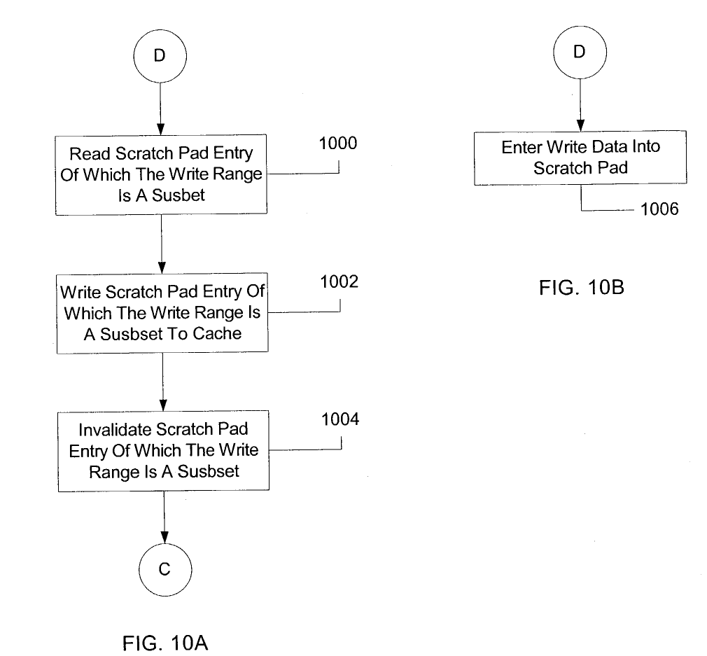

FIG. 10A depicts one set of steps that may be taken in response to a write command when it is determined that the write range is a subset of an entry in the scratch pad 508. An example of a scenario in which the write range is a subset of the scratch pad 508 is as follows. The scratch pad 508 holds logical blocks 1 through 50, and the range of the newly received write command is 20 through 30. In this instance, the disc drive responds by reading the scratch pad entry of which the write range is a subset (i.e., per this example the disc drive reads the data stored in the scratch pad 502 that is to be written to logical blocks 1 through 50), as shown in operation 1000. Next, as shown in operation 1002, the data read from the scratch pad 508 is written into the cache 502 as a new entry, and the cache table 504 is updated to reflect this new entry. Thereafter, as shown in operation 1004, the scratch pad entry of which the write range was a subset is invalidated. Thus, operations 1000, 1002, and 1004 cooperate to move the scratch pad entry of which the write range was a subset to the cache 502. In the wake of having executed these operations 1000, 1002, and 1004, the disc drive may then respond as though the write range was a subset of a cache entry—the disc drive goes on to perform the steps identified in FIG. 9.

FIG. 10B depicts another set of steps that may be taken in response to a write command when it is determined that the write range is a subset of an entry in the scratch pad 508. As an alternative to the procedure depicted in FIG. 10A, the disc drive may respond by simply entering the newly-received write data into the scratch pad 508 (i.e., overwriting the overlapping write data in the scratch pad 508), as shown in operation 1006.

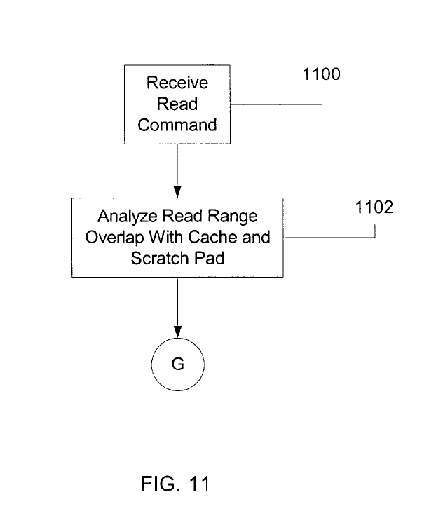

FIG. 11 depicts a detailed flow of operation with respect to execution of a read command in the context of a system utilizing both a cache 502 and a scratch pad 508. As can be seen from FIG. 11, the method is commenced by reception of a read command, as shown in operation 1100. A read command typically states the range (expressed in logical blocks) of data to be returned to the host 140 (FIG. 2). For much the same reasons as described above with respect to write commands, it is useful to determine overlaps between the read range and the data stored in the cache 502 and scratch pad 508. This process is performed in operation 1102, which may be executed via firmware or an application-specific integrated circuit designed to identify the overlapping data. The result of operation 1102 is information concerning which portion of the read range is found in the scratch pad 508, which portion is found on the cache 502, and which portion is found on the disc. In some cases, for example, the entirety of the read range may be found in the cache 502, the scratch pad 508, or the disc. In other cases, for example, the read range may be entirely absent from the cache 502, scratch pad 508, or the disc.

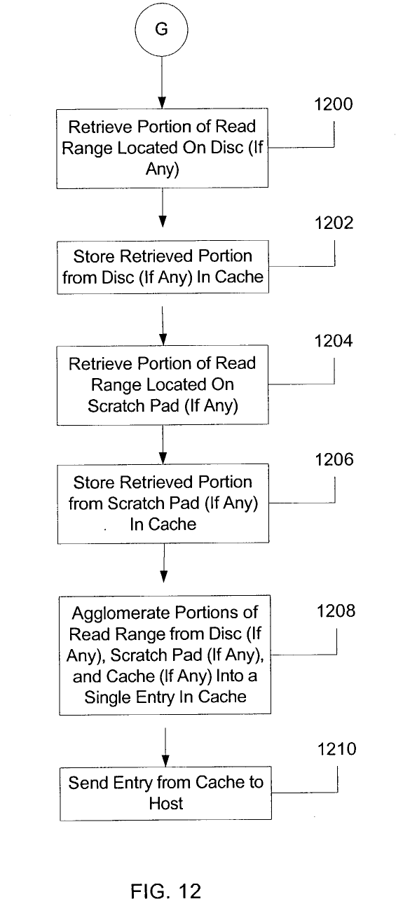

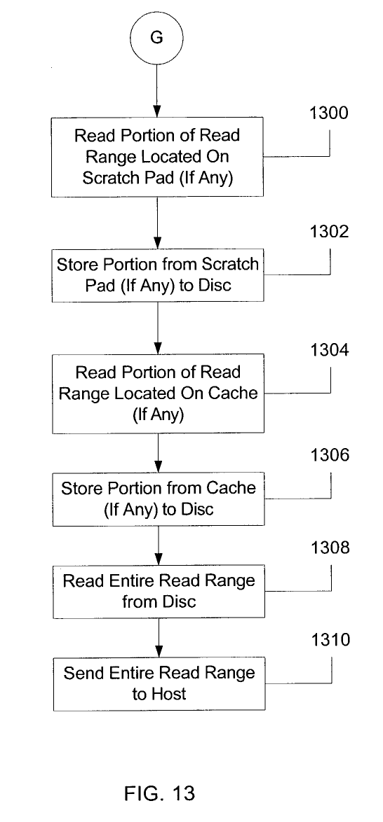

In the wake of having performed operation 1102, the disc drive may execute the flow of operations shown in either FIGS. 12 or 13. Either flow of operation results in the requested read range being returned to the host (FIG. 2). However, under certain circumstances, one flow of operation may be expected to be more efficient than the other. This is discussed further, below.

FIG. 12 depicts a flow of operation that may be executed in response to a read command. The general strategy of the flow of operation depicted in FIG. 12 is to accumulate all of the read data (whether it be found on the disc, the scratch pad 508, or in the cache 502) into a single entry in the cache 502. After accumulating the read data, it is transferred to the host (FIG. 2).

As shown in operation 1200, the disc drive initially reads the portion of the read range located on the disc. Of course, if none of the read range is located on the disc, this operation (and operation 1202) is skipped. Next, the portion of the read range read from the disc is entered into the cache 502, as shown in operation 1202. The cache table 504 is updated to reflect the entry. In short, operations 1200 and 1202 cooperate to move the portion of the read range found on the disc (if any) into the cache 502.

Similarly, operations 1204 and 1206 cooperate to move the portion of the read range found in the scratch pad 508 (if any) to the cache 502. In operation 1204, the disc drive reads the portion of the read range located on the scratch pad 508. If none of the read range is located on the scratch pad 508, this operation (and operation 1206) is skipped. Next, the portion of the read range read from the scratch pad 508 is entered into the cache 502, as shown in operation 1206. As before, the cache table 504 is updated to reflect the entry.

Next, in operation 1208, the various cache entries making up the read range are agglomerated into a single cache entry, using steps as described with reference to FIG. 8. Finally, as shown in operation 1210, the read data is transferred to the host (FIG. 2).

If the portions of the read range found on the scratch pad 508 have a lower logical block address than the portions found on the disc, the flow of operations 1200, 1202, 1204, and 1206 may be optionally reversed. Specifically, in such a case, the flow may proceed as follows: operation 1204, followed by operation 1206, followed by operation 1200, followed by operation 1202, followed by operation 1208, and finally 1210.

FIG. 13 depicts another flow of operation that may be executed in response to a read command. The general strategy of the flow of operation depicted in FIG. 13 is to dedicate all of the read data (whether it be found on the scratch pad 508 or in the cache 502) to its ultimate position on the disc, and to then read the entire read range from the disc. Thereafter, the read range is transferred to the host (FIG. 2).

As shown in operation 1300, the disc drive initially reads the portion of the read range located on the scratch pad 508. Of course, if none of the read range is located on the scratch pad 508, this operation (and operation 1302) is skipped. Next, the portion of the read range read from the scratch pad 508 is stored in its ultimate location on the disc, as shown in operation 1302. In short, operations 1300 and 1302 cooperate to move the portion of the read range found on the scratch pad 508 (if any) to its ultimate destination on the disc.

Similarly, operations 1304 and 1306 cooperate to move the portion of the read range found in the cache 502 (if any such portion has not been previously written to the disc) to its ultimate destination on the disc. It should be noted that the cache 502 contains two types of data: (1) “write” data, which is data that is to be written to the disc; and (2) “read” data, which is data that has been read from the disc, but has not yet been transferred to the host. “Read” data, therefore, can be assumed to already exist on the disc, and does not need to be moved thereto.

In operation 1304, the disc drive reads the portion of the read range located on the cache 502 as write data. If none of the read range is located on the cache 502 as write data, this operation (and operation 1306) is skipped. Next, the portion of the read range read from the cache 502 is stored in its ultimate location on the disc, as shown in operation 1306.

In operation 1308, the entire read range is read from the disc, as would be performed during a normal read operation. Finally, in operation 1310, the read data is transferred to the host (FIG. 2).

As was the case with the flow of operations shown in FIG. 12, if the portion of the read range found on the cache 502 has a lower logical block address than the portion found on the scratch pad 508, the flow of operations 1300, 1302, 1304, and 1306 may be optionally reversed. Specifically, in such a case, the flow may proceed as follows: operation 1304, followed by operation 1306, followed by operation 1300, followed by operation 1302, followed by operation 1308, and finally 1310.

The flow of operations shown in FIG. 12 may be expected to be more efficient in some situations, because it involves only two disc access operations (reading from the disc, as shown in operation 1200, and reading from the scratch pad, as shown in operation 1204). In comparison, the flow of operations depicted in FIG. 13 may involve four disc access operations: two read operations (reading from the scratch pad 508, as shown in operation 1300, and reading the entire read range from the disc, as shown in operation 1308) and two write operations (writing data from the scratch pad 508 and from the cache 502, to the disc, as shown in operations 1302 and 1306, respectively). Although the flow of operations depicted in FIG. 13 may be expected to take longer to execute, this flow may ultimately be more efficient, if the same range of data is to be read multiple times. This is because after a single execution of the flow in FIG. 13, all of the read data will have been dedicated to its ultimate location on the disc. Thus, a subsequent read operation of the same data involves only a single disc access operation (i.e., a read operation is as simple as reading the data from the disc and returning it to the host). Further, the flow of operations depicted in FIG. 13 generates an additional advantage, in that it provides for data in the scratch pad 508 to be committed to its ultimate location on the disc—a task that would otherwise have had to be performed at some later time.

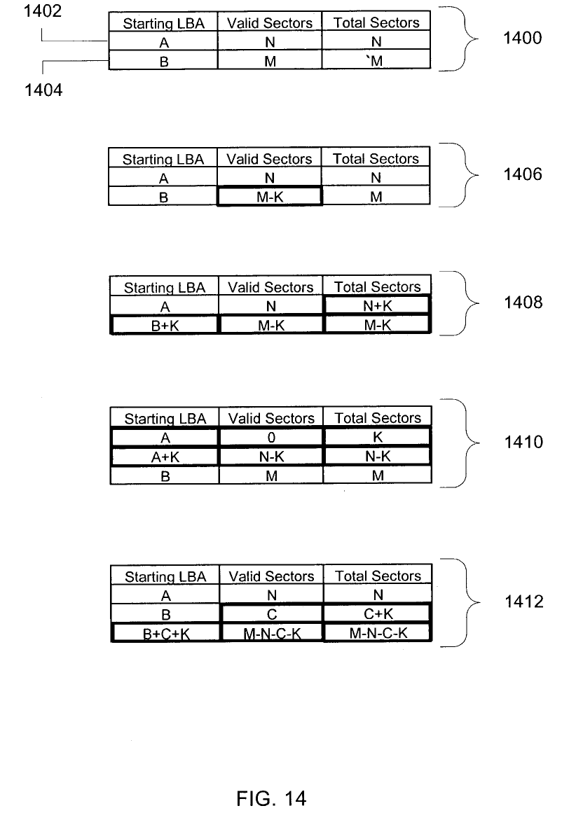

FIG. 14 illustrates tactics for updating and invalidating entries in the scratch pad table 512 (FIG. 5). A first scratch pad table 1400 is depicted in FIG. 14 and includes two entries 1402 and 1404. Each entry includes three fields of data: (1) the starting logical block of the data to which the entry refers; (2) the number of consecutive valid sectors, counted from the starting logical block, for the entry; and (3) the total number of sectors consumed by the entry, regardless of whether consumed by valid or invalid blocks of data. Thus, as depicted in FIG. 14, the first entry 1402 refers to data that is to be written on the disc, beginning at logical block A and ending at logical block A+N−1. All N logical blocks are valid. The second entry 1404 is an example of how the table 1400 is updated in the wake of adding data (M blocks of data, beginning at logical block B) to the scratch pad 508. Notably, the table 1400 is updated by adding the second entry 1404, which indicates that the scratch pad 508 includes a second set of data (which can be found in the scratch pad 508 by counting off N sectors from the beginning of the scratch pad 508) that is M sectors in length, all of which is valid. If another set of data were added to the scratch pad 508, the table 1400 would be updated by adding yet another entry to the table 1400. The hypothetical new set of data could be located by counting off N+M sectors from the beginning of the scratch pad 508.

The second table 1406 of FIG. 14 depicts the manner in which the first table 1400 is manipulated if the last K logical blocks of the data referred to by the second entry 1404 of the first table 1400 are to be invalidated. The last K logical blocks may be invalidated by simply subtracting K from the second field in the second table entry. Thus, the “valid sectors” field for the second entry reads “M−K,” meaning that only M−K logical blocks (beginning at logical block N+1) are eligible to be committed to disc. Notably, the “total sectors” field remains unchanged. This ensures that the data referred to by a hypothetical next entry would be properly located.

The third table 1408 of FIG. 14 depicts the manner in which the first table 1400 is manipulated if the first K logical blocks of the data referred to by the second entry 1404 are to be invalidated. The first K logical blocks may be invalidated by effectively redefining the first entry 1402 to extend an additional K logical blocks, without describing those logical blocks as being valid. Thus, the “total sectors” field of the first entry is manipulated to read “N+K.” The second entry is re-defined to begin at logical block B+K, and to have K fewer sectors (therefore, the “valid sectors” and “total sectors” fields both read “M−K.”). Essentially, the first entry is edited so as to “eat away” the first K logical blocks of data referred to by the second entry, thereby invalidating those first K blocks.

The fourth table 1410 of FIG. 14 depicts the manner in which the first table 1400 is manipulated if the first K logical blocks of the data referred to by the first entry 1402 are to be invalidated. (In this example, the approach referred to above cannot be used, because no entry precedes the first entry 1402). As can be seen from examination of the fourth table 1410, the table is manipulated to include an additional entry at the top of the table. The new entry invalidates the first K logical blocks by describing the initial K logical blocks (beginning at logical block A and ending at logical block A+K−1) as being invalid (i.e., the “valid sectors” entry is “0” for the newly created first entry). The original first entry is re-defined to begin at logical block A+K, and having K fewer sectors (the “valid sectors” and “total sectors” entries are modified to read “N−K”). Essentially, a new first entry is added to the table, and is used to eat away the first K sectors, in a manner identical to that as shown with reference to the third table 1408.

The fifth table 1412 of FIG. 14 depicts the manner in which the first table 1400 is manipulated if the middle K logical blocks (beginning at an offset of C logical blocks) of the data referred to by the second entry are to be invalidated. The approach depicted in the fifth table 1412 parallels the approach used in the fourth table 1410. As can be seen a new (third) entry is added to the table 1412. The second entry is modified so that only the first C sectors are considered valid, while referring to a total of C+K logical blocks. Thus, the final K logical blocks are invalid. The newly added entry begins immediately after the invalidated region at logical block B+C+K, and the remaining blocks are described as valid (the “valid sectors” field and the “total sectors” field for the final entry are modified to read “M−C−K”).

To summarize, a method of rapidly storing data to a data-retaining surface having a first data storage area (such as 302) and a second data storage (such as 304) area, wherein the second data storage area (such as 304) is susceptible of storing less data per unit of time than the first data storage (such as 302) area may include the following acts. A unit of data and a command to write the unit of data (such as 500) to a specified location in the second data storage area (such as 304) of the data-retaining surface (such as 300) is received from a host (such as 140). The unit of data (such as 500) is written (such as in operation 400) to the first data storage area (such as 302) of the data-retaining surface (such as 300). A first event, the occurrence of which indicates that the unit of data (such as such as 500) is to be moved to the second data storage area (such as 304) of the data retaining surface (such as 300), is awaited (such as in operation 408). The unit of data (such as 500) is written (such as in operation 410) to the specified location in the second data storage area (such as 304), after occurrence of the first event.

The data-retaining surface (such as 300) may be a substantially flat, annular magnetically encodable disc. Also, the first data storage area (such as 302) may be located peripherally on the surface of the disc (such as 300), as compared to the second data storage area (such as 304).

Prior to writing the unit of data (such as 500) to the first data storage area (such as 302) of the data-retaining surface (such as 300), the unit of data (such as 500) may be written (such as in operation 402) to a data storage device (such as 502) susceptible of storing more data per unit of time than the first data storage area (such as 302). After the occurrence of a second event (such as in operation 404), the data is written (such as in 408) to the first data storage area (such as 302) of the data-retaining surface (such as 300). Optionally, the data storage device (such as 502) may be an integrated circuit. The second event may defined by the data storage device (such as 502) storing more than a given number of the units of data received from the host (such as 140). Alternatively, the second event may be defined by failing to receive a command from the host (such as 140) for more than a given period of time.

A non-volatile memory device (such as 300) may store a table (such as 512) describing where data in the first data storage area (such as 302) is to be written, when the data is written to the second data storage area (such as 304).

The first event may be defined by the first data storage area (such as 302) storing more than a given number of the units of data received from the host (such as 140). Alternatively, the first event may be defined by failing to receive a command from the host (such as 140) for more than a given period of time.

Prior to writing the unit of data (such as 500) to the first data storage area (such as 302), a determination (such as in operation 602) may be made whether or not to write the unit of data (such as 500) to the first data storage area (such as 302) prior to writing the unit of data (such as 500) to the second data storage area (such as 304). The determination (such as in operation 602) may be based upon the size of the unit of data (such as 500) received from the host (such as 140). Alternatively, the determination (such as in operation 602) may be based upon the location in the second data storage area (such as 304) to which the unit of data (such as 500) is to be written. Further, the determination (such as in operation 602) may be based upon whether or not the unit of data (such as 500) is to be written in a location in the second data area (such as 304) that is juxtaposed to a second location in the second data storage area (such as 304) specified by a previous write command (such as 500) received from the host (such as 140).

According to another embodiment, a disc drive may include a microprocessor (such as 142) that receives commands from a host (such as 140), and a cache memory (such as 502) accessible by the microprocessor (such as 142). The disc drive may also include a transducer (such as 118) that writes to a disc (such as 108). The transducer (such as 118) may be disposed at the distal end of an actuator arm (such as 114), which may be propelled by a servo system (such as 150) under control of the microprocessor (such as 142). The disc (such as 300) has a first data storage area (such as 302) and a second data storage area (such as 304), wherein the second data storage area (such as 304) is susceptible of storing less data per unit of time than the first data storage area (such as 302). The microprocessor (such as 142) is programmed to undertake the acts as described above.

According to yet another embodiment, a disc drive may include a magnetically encodable disc. Further the disc drive may include a means (such as a processor programmed to carry out the steps as depicted in FIGS. 4-20) for receiving from a host a command to write a unit of data to the disc, and initially writing the unit of data to a peripheral region of the disc, and upon the occurrence of an event, writing the unit of data to a region of the disc that is more centrally located than the peripheral region.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, although this disclosure has discussed the invention with reference to a specific set of fields, tables, and table manipulation tactics, one skilled in the art understands that many other forms of fields, tables, and table manipulation tactics could be used. The scratch pad table could include a field allowing valid sectors to be described as beginning at an offset from the first logical block. Additionally, the invention may be used in the context of any data storage device that records data on a physical medium, in which certain regions of the medium are susceptible of data recordation at rates faster than other regions. Furthermore, the invention may make use of more than two levels of buffering, although the discussion herein referred to a system using only two levels (cache and scratch pad). Numerous other changes may be made which will readily suggest themselves to those skilled in the art and which are encompassed in the invention disclosed and as defined in the appended claims.

1. A method comprising the steps of:
receiving a unit of data to be written to a second data storage area of a data-retaining device;
writing the unit of data to a first data storage area of the data-retaining device;
waiting for a first event, the occurrence of which indicates that the unit of data is to be moved to the second data storage area of the data retaining device; and
writing the unit of data to the second data storage area.

2. The method of claim 1, wherein the data-retaining device comprises a substantially flat, annular magnetically encodable disc.

3. The method of claim 2, wherein the first data storage area is located peripherally on the surface of the disc, as compared to the second data storage area.

4. The method of claim 1, wherein:
prior to writing the unit of data to the first data storage area of the data-retaining device, the unit of data is written to a data storage unit susceptible of storing more data per unit of time than the first data storage area; and
after the occurrence of a second event, the data is written to the first data storage area of the data-retaining device.

5. The method of claim 4, wherein the data storage unit comprises an integrated circuit.

6. The method of claim 4, wherein the second event is defined by the data storage device storing more than a given number of the units of data.

7. The method of claim 4, wherein the second event is defined by failing to receive a command for more than a given period of time.

8. The method of claim 1, further comprising:
storing in a non-volatile memory device a table describing where data in the first data storage area is to be written, when the data is written to the second data storage area.

9. The method of claim 1, wherein the first event is defined by the first data storage area storing more than a given number of the units of data.

10. The method of claim 1, wherein the first event is defined by failing to receive a command for more than a given period of time.

11. The method of claim 1, wherein prior to writing the unit of data to the first data storage area, a determination is made whether or not to write the unit of data to the first data storage area prior to writing the unit of data to the second data storage area.

12. The method of claim 11, wherein the determination is based upon the size of the unit of data.

13. The method of claim 11, wherein the determination is based upon the location in the second data storage area to which the unit of data is to be written.

14. The method of claim 11, wherein the determination is based upon whether or not the unit of data is to be written in a location in the second data area that is juxtaposed to a second location in the second data storage area specified by a previous write command.

15. An apparatus comprising a disc that has a first data storage area and a second data storage area, the second data storage area being susceptible of storing less data per unit of time than the first data storage area; wherein the apparatus is adapted to:
write a unit of data to the first data storage area of the disc;
wait for a first event, the occurrence of which indicates that the unit of data is to be moved to the second data storage area of the disc; and
write the unit of data to the specified location in the second data storage area, after occurrence of the first event.

16. The apparatus of claim 15, wherein the first data storage area is located peripherally on the surface of a disc, as compared to the second data storage area.

17. The apparatus of claim 15, wherein the apparatus is adapted to:
prior to writing the unit of data to the first data storage area of the disc, writing the unit of data to a cache memory; and
after the occurrence of a second event, writing the data to the first data storage area of the disc.

18. The apparatus of claim 17, wherein the second event is defined by the cache memory storing more than a given number of the units of data received from the host.

19. The apparatus of claim 17, wherein the second event is defined by failing to receive a command from the host for more than a given period of time.

20. The apparatus of claim 15, wherein the apparatus is adapted to store in a non-volatile memory device a table describing where data in the first data storage area is to be written, when the data is written to the second data storage area.

21. The apparatus of claim 20, wherein the non-volatile memory device comprises a portion of the disc.

22. The apparatus of claim 15, wherein the first event is defined by the first data storage area storing more than a given number of the units of data received from the host.

23. The apparatus of claim 15, wherein the first event is defined by failing to receive a command from the host for more than a given period of time.

24. The apparatus of claim 15, wherein the is further adapted to, prior to writing the unit of data to the first data storage area, determining whether or not to write the unit of data to the first data storage area prior to writing the unit of data to the second data storage area.

25. The apparatus of claim 24, wherein the determination is based upon the size of the unit of data received from a host.

26. The apparatus of claim 24, wherein the determination is based upon the location in the second data storage area to which the unit of data is to be written.

27. The apparatus of claim 24, wherein the determination is based upon whether or not the unit of data is to be written in a location in the second data area that is juxtaposed to a second location in the second data storage area specified by a previous write command received from the host.

28. A storage device comprising:
a storage medium; and
a means for receiving a command to write a unit of data to the medium, and initially writing the unit of data to a first region of the medium that has faster access than a second region, and upon the occurrence of an event, writing the unit of data to the second region of the medium.

29. The storage device of claim 28, further comprising:
a cache memory that stores the unit of data prior to the unit of data being written to the first region of the medium.

30. The disc drive of claim 28, wherein the disc stores a table describing where data located in the first region is to be stored when it is written to the second region of the medium.

31. The storage device of claim 28 wherein the first region is a peripheral region.
